(19) United States
(12) Patent Application Publication
(10) Pub. No.: US 2014/0032429 A1
(43) Pub. Date: Jan. 30, 2014

(54) SYSTEM AND METHOD FOR GENERATING DISCOVERY RESPONSES

(71) Applicant: Spencer Pahlke, San Francisco, CA (US)

(72) Inventor: Spencer Pahlke, San Francisco, CA (US)

(21) Appl. No.: 13/559,604

(22) Filed: Jul. 27, 2012

(51) Int. Cl. G06Q 10/10; G06Q 50/18

(52) U.S. Cl. CPC G06Q 10/10; G06Q 50/18
USPC 705/311

(57) ABSTRACT

The present is directed to managing information from a legal party in response to one or more discovery questions presented by another legal party in a legal proceeding. A generated case profile for the legal proceeding is established, wherein the case profile includes information the legal proceeding and the legal parties. One or more discovery questions received from another legal party, for the legal party to answer, is identified. A first inquiry is displayed to the legal party via the user interface, wherein the first inquiry is associated with the selected one or more discovery questions. A first response is received from the legal party via the user interface, wherein the first response is associated with the information requested by the first inquiry. A discovery question response to at least one identified discovery question is generated, wherein the discovery question response includes at least the first response.

### FIELD

The present disclosure is directed to a system and method for generating discovery responses.

### BACKGROUND

Responding to legal discovery questions is a necessary and important aspect of the information gathering process related to a legal proceeding. Discovery questions, such as interrogatories, requests for production, and the like, allow attorneys to identify essential issues necessary to evaluate the case and prepare for depositions and trial or mediation/arbitration. The process of responding to discovery questions, however, is often inefficient, requiring a significant amount of attorney time. The time required to respond to the discovery questions increases both the length and the cost of litigation. In particular, discovery questions often seek information in a manner, or present questions in an order, that is not intuitive or logical to the client attempting to respond. As such, the attorney must present the questions in a logical fashion to the client and then transform the gathered information into a response. There is a need for a more efficient method of generating discovery responses.

### SUMMARY

The present is directed to managing information from a legal party in response to one or more discovery questions presented by another legal party in a legal proceeding. A generated case profile for the legal proceeding is established, wherein the case profile includes information the legal proceeding and the legal parties. One or more discovery questions received from another legal party, for the legal party to answer, is identified. A first inquiry is displayed to the legal party via the user interface, wherein the first inquiry is associated with the selected one or more discovery questions. A first response is received from the legal party via the user interface, wherein the first response is associated with the information requested by the first inquiry. A discovery question response to at least one identified discovery question is generated, wherein the discovery question response includes at least the first response.

### BRIEF DESCRIPTION OF THE DRAWINGS

FIG. 1 illustrates an exemplary environment including a computing device having a discovery module in accordance with an aspect the present disclosure;

FIG. 2 illustrates a block diagram of the computing device with the discovery module in accordance with an aspect of the present disclosure; and

FIG. 3 illustrates a flow chart representative of at least a portion of a method for generating discovery responses in accordance with an aspect of the present disclosure.

### DETAILED DESCRIPTION

In general, the system and method of the present disclosure provides a number of advantages including efficiently selecting and generating discovery responses based on received information associated with a legal matter. With this technology, discovery responses may be generated without the need for time-consuming and costly interactions between the client and an attorney. The necessary relevant information related to the legal action is gathered from a client or client representative via a user interface in a logical and intuitive manner based on discovery questions chosen by another legal party to the legal action. The responses are then displayed on a display screen or are able to be printed out for review. Discovery responses can then be generated in a format to be provided to any party involved in the legal matter.

It should be noted that discovery questions may be considered any legal instrument or tool used in a legal dispute in which one legal party is attempting to gather information from another legal party. In an aspect, the discovery questions may include, but not be limited to, interrogatories, requests for production, requests for admission and the like.

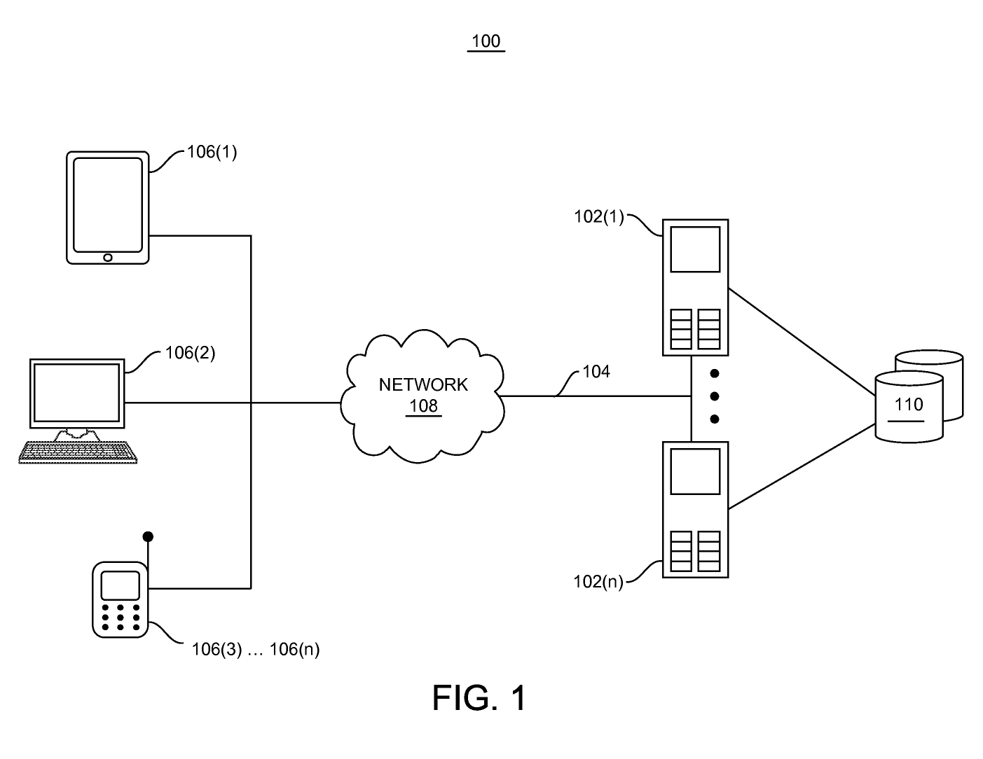

FIG. 1 illustrates a diagram of an example system environment that utilizes one or more computing devices implementing a discovery module in accordance with an aspect of the present disclosure. In particular, the example system environment 100 includes a plurality of computing devices. It should be noted that the term “computing devices” can be referred to as encompassing one or more client devices, one or more physical and/or virtual servers, one or more databases, cloud computing devices, intermediary gateway and/or router devices, mobile telecommunications network devices, and the like. It should be noted that although the term “computing device” may be referred to herein in the plural, it is contemplated that only one computing device may be considered without being limiting to the language used herein. It should be understood that the particular configuration of the system 100 shown in FIG. 1 is provided for exemplary purposes only and is thus not limiting.

The servers 102(1)-102(n) include but are not limited to application servers, database servers, computation farms, data centers, virtual machines, cloud computing devices, mail or web servers and the like. The servers 102(1)-102(n) and the client devices 106(1)-106(n) may be connected to a local area network (LAN) 104 and/or a wide area network 108. The servers 102(1)-102(n) comprise one or more computing devices or machines capable of operating one or more Web-based and/or non Web-based applications that may be accessed by other computing devices (e.g. client devices, other servers) via the network 108. One or more servers 102(1)-102(n) may be front end Web servers, application servers, and/or database servers. Such data includes, but is not limited to Web page(s), image(s) of physical objects, user account information, and any other objects and information. It should be noted that the servers 102(1)-102(n) may perform other tasks and provide other types of resources. One or more servers 102 may comprise a cluster of a plurality of servers which are managed by a firewall, load balancer, web accelerator, gateway device, router, hub, intermediary network traffic management device and the like (not shown). In an aspect, one or more servers 102(1)-102(n) may implement a version of Microsoft® IIS servers, RADIUS/DIAMETER servers and/or Apache® servers, although other types of servers may be used and other types of applications may be available on the servers 102(1)-102(n).

Client devices 106(1)-106(n) comprise computing devices capable of connecting to other computing devices, such as the servers 102(1)-102(n) and/or database(s) 110. Such connections are performed over wired and/or wireless networks, such as network 108, to send and receive data, such as Web-based and/or non Web-based requests, receiving responses to requests and/or performing other tasks, in accordance with the novel processes described herein.

Non-limiting and non-exhausting examples of such client devices 106(1)-106(n) include, but are not limited to, personal computers (desktops, laptops), mobile phones and/or smart phones, pagers, tablet devices, PDAs and the like. In an aspect, the client device 106 may be configured to run a Web browser or other software module that provides a user interface for human users to interact with and access a discovery module, as will be described in more detail below. In an aspect, the client device may include a locally stored mobile application which allows the user to request resources and/or information from servers, databases and/or other client devices via the mobile application. For example, the client device 106 may have a mobile application that allows access to the discovery module.

Network 108 comprises a publicly accessible network, such as the Internet, which handles communication between the client devices 106(1)-106(n), servers 102(1)-102(n) and database(s) 110. However, it is contemplated that the network 108 may comprise other types of private and/or public networks. Communications between the computing devices preferably take place over the network 108 according to network protocols, such as the HTTP, UDP, and TCP/IP protocols and the like.

Further, it should be appreciated that the network 108 may include local area networks (LANs), wide area networks (WANs), direct connections and any combination thereof, as well as other types and numbers of network types. On an interconnected set of LANs or other networks, including those based on differing architectures and protocols, routers, switches, hubs, gateways, bridges, and other intermediate computing devices may act as links within and between LANs, WANs and other networks to enable messages and other data to be sent and received between computing devices. Also, communication links within and between LANs and other networks typically include twisted wire pair (e.g., Ethernet), coaxial cable, analog telephone lines, mobile cell towers using RADIUS or DIAMETER protocols, full or fractional dedicated digital lines including T1, T2, T3, and T4, Integrated Services Digital Networks (ISDNs), Digital Subscriber Lines (DSLs), wireless links including satellite links and other communications technologies.

As shown in FIG. 1, the environment 100 may include one or more databases 110 coupled to the computing devices 102, 106 in which the databases 110 are configured to allow storage and access to data, files or other information utilized or generated by the discovery module 210. In an aspect, one or more databases 110 may be configured to store a dynamic questionnaire that includes questions or inquires that are mapped to corresponding identified discovery questions received from another party in the legal dispute. In an aspect, the one or more databases 110 may be configured to store case profiles generated, updated and/or modified by the discovery module 210 such that the information in the case profiles can be easily retrieved by one or more individuals working on the associated legal matter. Databases are well known in the art, and details regarding databases 110 will not be described herein.

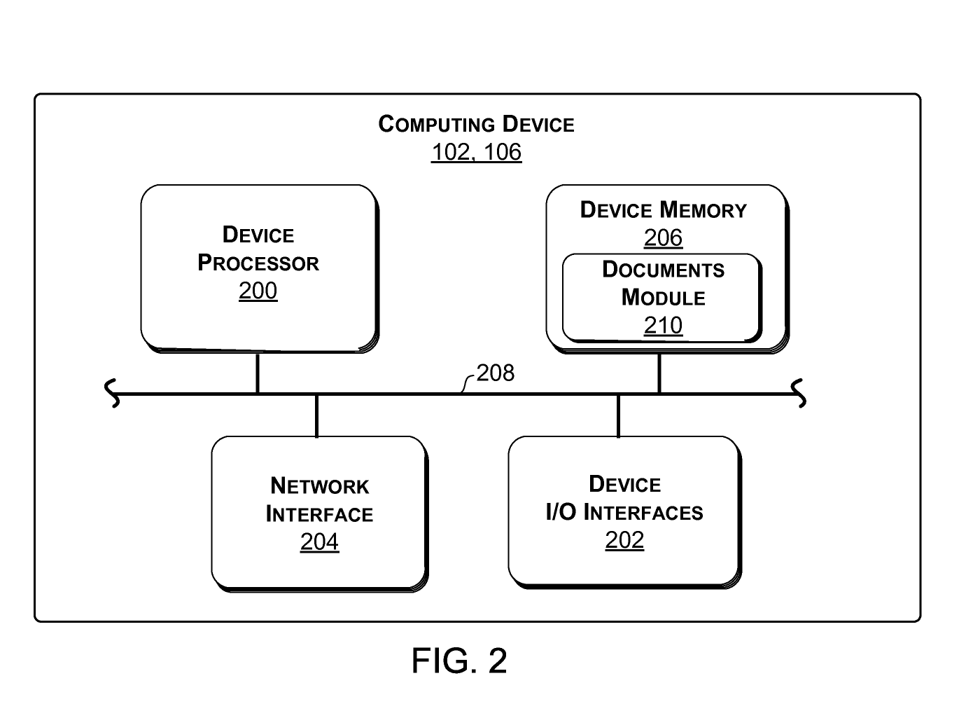

FIG. 2 illustrates a block diagram of a computing device utilizing the discovery module in accordance with an aspect of the present disclosure. With regard to FIG. 2, the computing device may be one or more physical or virtual servers 102 and/or one or more client devices 106. The computing device 102, 106 includes one or more device processors 200, one or more device I/O interfaces 202, one or more network interfaces 204 and one or more device memories 206, all of which are coupled together by one or more buses 208. It should be noted that the computing device 102, 106 could include other types and numbers of components. In addition, the computing device 102, 106 includes a discovery module 210, as shown in FIG. 2. Accordingly, a portion of or the entire discovery module 210 may be housed in and executed by one or more server devices 102(1)-102(n) and/or one or more client devices 106(1)-106(n).

Device processor 200 comprises one or more microprocessors configured to execute computer/machine readable and executable instructions stored in the respective local or remote device memory 206. Such instructions, such as instructions associated with the discovery module 210, are executed by the processor 200 cause it to perform one or more functions described herein. It is understood that the processor 200 may comprise other types and/or combinations of processors, such as digital signal processors, micro-controllers, application specific integrated circuits (“ASICs”), programmable logic devices (“PLDs”), field programmable logic devices (“FPLDs”), field programmable gate arrays (“FPGAs”), and the like.

Device I/O interfaces 202 of the computing device 102, 106 comprise one or more user input and output device interface mechanisms. The interface may include a computer keyboard, mobile device keypad, touchpad, touchscreen, mouse, display device, and the corresponding physical ports and underlying supporting hardware and software to enable communications with other computing devices in the system 100. Such communications include, but are not limited to, accepting user data input and providing output information to a user, programming, accessing one or more memory devices and administering one or more functions to be executed by the corresponding device and the like.

Network interface 204 comprises one or more mechanisms that enable the computing device 102, 106 to engage in TCP/IP (or other) communications with another computing device over the LAN 104 and/or network 108. Network interface 204 is sometimes referred to as a transceiver, transceiving device, or network interface card (NIC), which transmits and receives network data packets over one or more networks. In an aspect where the computing device 102, 106 includes more than one device processor 200 (or a processor 200 has more than one core), each processor 200 (and/or core) may use the same single network interface 204 or a plurality of network interfaces 204 to communicate with other computing devices. Further, the network interface 204 may include one or more physical ports, such as Ethernet ports, to couple its respective device with other computing devices in the system 100.

Bus 208 may comprise one or more internal device component communication buses, links, bridges and supporting components, such as bus controllers and/or arbiters. The bus enable the various components of the computing device such as the processor 200, device I/O interfaces 202, network interface 204, and device memory 206, to communicate with one another. However, it is contemplated that the bus may enable one or more components of its respective computing device to communicate with components in other devices as well. Example buses include HyperTransport, PCI, PCI Express, InfiniBand, USB, Firewire, Serial ATA (SATA), SCSI, IDE and AGP buses. However, it is contemplated that other types and numbers of buses may be used, whereby the particular types and arrangement of buses will depend on the particular configuration of the computing device which houses the bus.

Device memory 206 of the computing device 102,106 comprises non-transitory computer readable media, namely computer readable or processor readable storage media, which are examples of machine-readable storage media. Computer readable storage/machine-readable storage media may include volatile, nonvolatile, removable, and non-removable media implemented in any method or technology for storage of information. As mentioned above, the device memory 206 stores computer readable/machine-executable instructions, data structures, program modules and components, or other data, which may be obtained and/or executed by one or more processors, such as device processor 200. Examples of computer readable storage media include RAM, BIOS, ROM, EEPROM, flash/firmware memory or other memory technology, CD-ROM, digital versatile disks (DVD) or other optical storage, magnetic cassettes, magnetic tape, magnetic disk storage or other magnetic storage devices, or any other non-transitory medium which can be used to store the desired information.

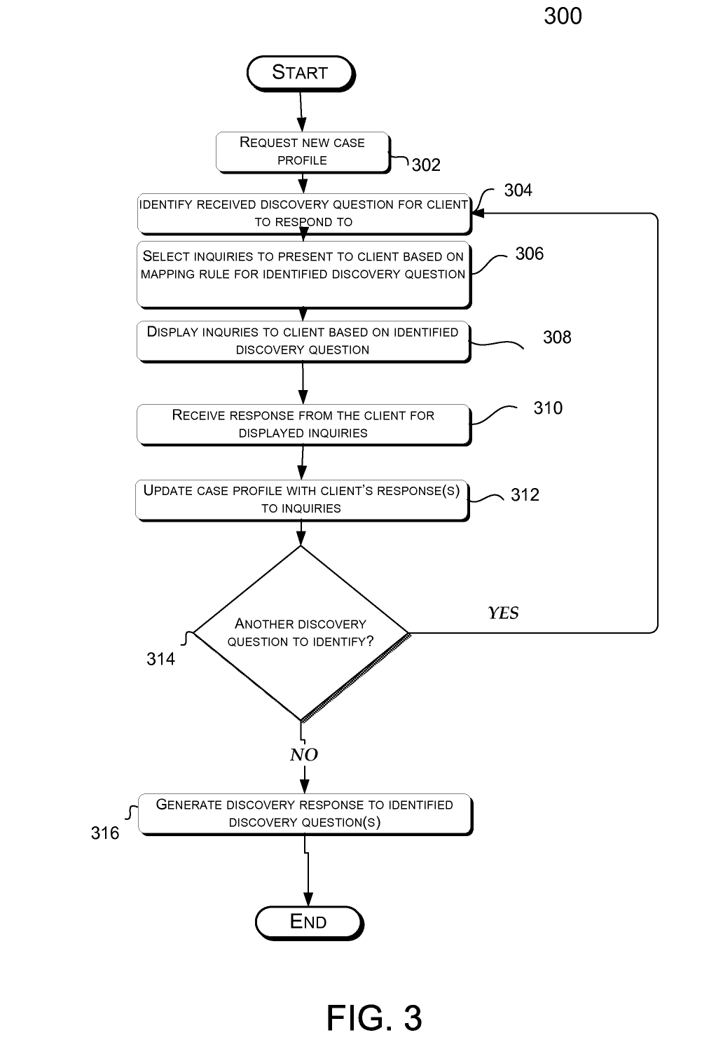

As shown in FIG. 2, a discovery module 210 is shown within the memory 206 and comprises computer readable/machine executable instructions. It is contemplated that the discovery module 210 may alternatively be stored in another memory external to the memory 206 in another computing device 106 or database 110. As stated above, such stored executable instructions allow the processor 200 to perform actions, including implementing an operating system for controlling the general operation of the client device 106 and/or server 102 to perform one or more portions of the novel process described below and in FIG. 3.

In general, the discovery module 210 is configured to aid one or more clients or other individuals representing the client (hereinafter “client”) involved in a legal dispute or litigation proceeding with the discovery process, and in particular providing responses to discovery questions. In particular, the discovery module 210 generates a case profile for the client based on preliminary information that is either provided by the client.

The discovery module 210 is configured to analyze entered and stored information from the client which allows the module 210 to automatically select and organize the stored information into a prepared response to one or more discovery questions. During the discovery process, the client may receive one or more discovery questions received or served from another legal party, in which the client must answer the identified discovery questions in the form of discovery responses. The discovery module 210 utilizes a dynamic questionnaire database containing inquiries or questions that are presented to the client to provide a response. In an aspect, each inquiry or question of the dynamic questionnaire is mapped or correlated to one or more discovery questions, such that the discovery module 210 can automatically select one or more inquiries or questions to present to the client based on which discovery questions have been provided by the other legal party.

In an optional aspect, the discovery module 210 may be configured to apply logic which allows it to analyze obtained information from the user regarding facts of the legal action to automatically select one or more discovery questions which may be used to send to another party in the legal action.

The discovery module 210 then displays the selected inquiries to the client via the user interface. The discovery inquiries may be designed to be dynamic in nature, such that the discovery module 210 will present different inquiries based on the client's answer(s) to one or more previous inquires. The discovery module 210 receives the user answers and stores them to the case profile for later retrieval.

In the event that another legal party serves one or more discovery questions, the discovery module 210 is able to quickly and efficiently retrieve the client's answers based on the identified discovery questions and then generate discovery responses containing the client's answers in an appropriately organized and formatted manner.

The discovery module 210 is configured to provide a web-based or non web-based application including a user interface which allows one or more clients to enter, view, modify and generate information associated or involved with the discovery process. In particular, such clients are deemed to be involved or have knowledge/information that is relevant to the discovery process. Others who may utilize the discovery module 210 include, but are limited to, the client's attorney, attorney staff, in house attorneys and staff, as well as opposing counsel, co-counsel, court clerks, expert witnesses and non-expert witnesses and the like. It is also contemplated that the discovery module 210 may access and obtain information relevant to the case from sources other than the clients (e.g. 3^{rd} party databases, news sources, police reports, autopsy findings, and the like).

The discovery module 210 is configured to further allow one or more attorneys involved in the legal matter to enter, modify, access, store and organize information stored in the particular client's case profile. By way of example, the attorney may be able to store and organize information regarding the client, the status of the case, settlement negotiations, and/or potential liens, although other types of information relevant to the legal action.

It is contemplated that the discovery module 210 can apply security mechanisms and protocols to prevent unauthorized individuals from viewing, entering, modifying and otherwise accessing information of one or more other users who have provided information associated with the legal matter. For instance, if the attorney has unrestricted rights, the discovery module 210 will allow the attorney to view, enter, modify or otherwise access already entered information for all users associated with the legal action who have provided information to the discovery module 210. In contrast, the user having restricted rights will only be able to view, enter, modify or otherwise access information in regard to that user's allowed rights per policy enforcements.

FIG. 3 illustrates a flow chart associated with a plurality of steps performed by the discovery module in accordance with an aspect of the present disclosure. As shown in FIG. 3, for a new case, the attorney logs into the discovery module 210 via the user interface and provides a case matter number, login/password credentials, and/or other appropriate information. In the event that the client is accessing the discovery module 210, the client may enter a code provided by an attorney handling the legal matter, whereby the discovery module 210 will initiate the new case profile process. Once the client has successfully accessed the discovery module 210, a new case profile will generated for the legal proceeding, which is also stored in a memory/database (Block 302). It is also contemplated that a case profile may already exist, in which the discovery module is able to retrieve and load it from memory.

After the case profile is created or loaded by the discovery module 210, the discovery module 210 may be configured to request, via the user interface, one or more discovery questions that have been identified and served by another legal party to the legal dispute (Block 304). In an aspect, the client may manually enter the identified discovery questions via the user interface. In an aspect, the discovery module 210 may receive the identified discovery questions electronically from the serving party, wherein the discovery module 210 automatically processes the identified discovery questions, thereby bypassing manual entry of such information.

Once the discovery questions are identified by the discovery module 210, the module 210 is able to identify and select the one or more relevant inquiries which are to be asked to the client (Block 306). In particular, the discovery module 210 queries a mapping rule for each identified discovery questions to identify which inquiries are to be selected and presented to the client via the user interface (Block 308).

In an aspect, the discovery module 210 may initially display a plurality of questions which prompts the attorney and/or client to enter preliminary, general, or specific information regarding facts associated with the legal proceeding. Such requested information may include, but are not limited to, the type of legal proceeding involved and asserted causes of action (e.g. personal injury action, criminal action, breach of contract action), names and contact information of the parties involved (e.g. potential and/or actual plaintiff(s), defendant(s), witness(es)), opposing counsel, court information (e.g. state or federal, district/appeals/supreme), local rules information, and the like. The discovery module 210 may display prompts requesting information of employment status of the parties; information regarding the incident, including the time and date of the incident, police reports, filed governmental documents and other evidence related to the incident. In the event that the legal proceeding is a personal injury matter, the discovery module 210 may display prompts requesting information about the client's injuries and associated treatment; and/or information regarding other claims such as loss of consortium or emotional distress. It is contemplated that the information sought above are exemplary only and that inquiries may request other information regarding the legal proceeding.

The discovery module 210 may display, via the client interface, one prompt at a time or may display a set of prompts, although other numbers and combinations of questions may be displayed via the user interface. One or more of the plurality of prompts may optionally display a help button that, when selected by the attorney/user, may provide additional information to assist the attorney/user in responding to the associated prompt. It is contemplated that one or more questions may alternatively include predetermined responses from which the attorney/user is directed to select from the display response choices. It is also contemplated the one or more questions may have a drop down menu from which the attorney/user can select the answer.

In an aspect, one or more inquiries may be part of a decision tree which comprises dependent inquiries which the discovery module 210 selects and displays based on one or more previous answers. Accordingly, the inquiries (as well as discovery questions) may be configured in a tree-like structure, whereby certain questions may be selected and displayed by the discovery module 210 based on one or more previous received answers. By way of example, an inquiry such as “Did the incident occur at an intersection?” displayed via the user interface can have different follow up inquiries based on the user's answer. For instance, if the user responds “No”, the discovery module 210 may present a follow-up question asking “Describe where the incident occurred.” In contrast, if the user responds “Yes,” then the discovery module 210 may select and display one or more follow up example questions such as “What are the names of the intersecting streets?”; “Describe the traffic signs and signals at the intersection”; and/or “Was there a traffic signal facing you at the time of the incident?”

In an aspect, the inquiries of the questionnaire may be preestablished and stored in a database. In an aspect, the inquiries may be customizably generated by one or more individuals and uploaded to the database.

For each inquiry prompt displayed by the discovery module 210, the discovery module 210 receives one or more answers from the client via the user interface (Block 310). The answers are stored in a memory and/or database and the case profile is updated by the discovery module 210 to reflect the received information (Block 312). Additionally, the discovery module 210 ensures that the client's response is mapped to the corresponding discovery question with which the inquiry is correlated or mapped to.

In an example aspect, based on the responses received from the inquiries, the discovery module 210 may be able to select a set of one or more proposed discovery questions that the discovery module 210 deems relevant to legal action. The attorney, via the user interface, may be able to view the proposed discovery questions and select the discovery questions that s/he wishes to serve to opposing counsel.

In this example aspect, the discovery questions in the database 110 may be established or “form” discovery questions and/or be customized discovery questions. The one or more established discovery questions may be provided based on the discovery questions served by the opposing counsel, although other methods of providing the discovery questions may be used. The served discovery questions may be uploaded, organized, and stored in the database. Alternatively, form discovery questions, such as the state form discovery questions, or commonly used discovery questions from prior actions may be uploaded, organized, and stored in the database. In one aspect, the one or more discovery questions may be provided directly from the database. For form discovery questions, the one or more established discovery questions may be provided based on a request from the opposing counsel to respond to the specific form discovery questions. For commonly used discovery questions, the one or more discovery questions may be selected based on the attorney/user answers.

In this example aspect, the discovery questions may be selected by the discovery module 210 by utilizing key word recognition logic that indicates relevant discovery questions based on the responses received or vice versa. It is contemplated that other methods of identifying discovery questions based on the responses to one or more of the plurality of questions may be used. By way of example only, the discovery module 210 may contain instructions stored in the memory 208 for performing a key word search based on a provided discovery question to determine information obtained in attorney/user responses that may be relevant to the provided discovery question. The discovery response may then be generated using the information obtained through the key word search. The methods of generating responses to the discovery questions described herein are non-exhaustive and non-limiting as other methods of generating discovery responses may be used.

As shown in FIG. 3, the process repeats for each discovery question presented by the other legal party (Block 314). Once all of the discovery questions have been addressed, the discovery module generates a discovery response document which includes the information/responses provided by the client, wherein the client's responses are automatically organized by the discovery module 210 to answer each provided discovery question (Block 316). Additionally/alternatively, the discovery module may display the discovery response document for attorney review prior to being provided to the requesting legal party. In an aspect, the discovery module 210 may allow the attorney to modify the discovery responses to the discovery questions. In an aspect, the discovery module 210 allows the attorney to evaluate, such that the mapping between the plurality of questions and the provided discovery question may be adjusted based on the attorney review for future responses to the same or similar discovery question.

In an aspect, the discovery module 210 may display, via the user interface, a list of common objections that may be selectively applied to one or more of the displayed discovery questions and the associated generated responses. By way of example, the list of objections may include, but are not limited to, unduly burdensome, overbroad, subject to attorney-client privilege, repetitive, vague, and/or irrelevant, although other objections may be provided. The attorney may selectively apply one or more of the displayed objections to one or more of the generated discovery responses.

As stated, the discovery module 210 may generate a physical or electronic document containing the provided discovery questions, the generated responses and the selectively applied objections. In an aspect, the discovery module 210 has formatting capabilities to allow the document to be formatted and served to the opposing party. By way of example only, the document may include information such as the case heading, general objections, and attorney information, although the document may include other information necessary to format the document to be served on the opposing party.

Accordingly, as illustrated and described with reference to the examples herein, this technology provides a number of advantages including providing effective methods and devices for generating discovery responses. With this technology, discovery responses may be generated without the need for time-consuming and costly interactions between the client and an attorney. The system gathers the necessary relevant information related to a legal action from the client in a logical and intuitive manner. The information is then used to create responses to identified discovery questions relevant to the legal action. The responses are then displayed for attorney review and the application of standard objections. The system then generates the discovery responses in a format to be served on the opposing party.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A method of managing information received from a legal party in response to one or more discovery questions presented by another legal party in a legal proceeding, the method comprising:
processing a case profile associated with a legal proceeding between two or more parties, wherein the case profile includes information of at least the legal proceeding and the two or more parties;
identifying one or more discovery questions for the legal party to answer, wherein the discovery questions are received from the another legal party;
displaying a first inquiry to the legal party via the user interface, wherein the first inquiry is associated with the selected one or more discovery questions;
receiving a first response from the legal party via the user interface, wherein the first response is associated with the information requested by the first inquiry; and
generating a discovery question response to at least one identified discovery question, wherein the discovery question response includes at least the first response.

2. The method of claim 1, further comprising dynamically selecting a second inquiry to be displayed to the legal party based on the first response received.

3. The method of claim 1, further comprising designating at least one discovery question to serve to an opposing legal party from the one or more discovery questions determined to be relevant to the legal proceeding.

4. The method of claim 1, further comprising: generating a document containing the plurality of discovery questions.

5. The method of claim 1, further comprising:
retrieving one or more proposed objections for each identified discovery question;
displaying the one or more retrieved proposed objections in the user interface, wherein at least one proposed objection is selectable via the user interface; and
generating a document containing the plurality of discovery responses and corresponding requested discovery question and the corresponding selected one or more objections.

6. A computer readable medium having stored thereon instructions for managing information received from a legal party in response to one or more discovery questions presented by another legal party in a legal proceeding, comprising computer executable code which when executed by at least one processor, causes the processor to:
process a case profile associated with a legal proceeding between two or more parties, wherein the case profile includes information of at least the legal proceeding and the two or more parties;
identify one or more discovery questions for the legal party to answer, wherein the discovery questions are received from the another legal party;
display a first inquiry to the legal party via the user interface, wherein the first inquiry is associated with the selected one or more discovery questions;
receive a first response from the legal party via the user interface, wherein the first response is associated with the information requested by the first inquiry; and
generate a discovery question response to at least one identified discovery question, wherein the discovery question response includes at least the first response.

7. The computer readable medium of claim 6, wherein the processor is further configured to dynamically select a second inquiry to be displayed to the legal party based on the first response received.

8. The computer readable medium of claim 6, wherein the processor is further configured to designate at least one discovery question to serve to an opposing legal party from the one or more discovery questions determined to be relevant to the legal proceeding.

9. The computer readable medium of claim 6, wherein the processor is further configured to generate a document containing the plurality of discovery questions.

10. The computer readable medium of claim 6, wherein the processor is further configured to:
retrieve one or more proposed objections for each identified discovery question;
display the one or more retrieved proposed objections in the user interface, wherein at least one proposed objection is selectable via the user interface; and
generate a document containing the plurality of discovery responses and corresponding requested discovery question and the corresponding selected one or more objections.

11. A computing device comprising:
a network interface capable of receiving and transmitting data packets over one or more networks;
a memory configured to store one or more programming instructions configured to manage information received from a legal party in response to one or more discovery questions presented by another legal party in a legal proceeding; and
a processor configured to execute the stored programming instructions in the memory which, when executed by the processor, cause the processor:
process a case profile associated with a legal proceeding between two or more parties, wherein the case profile includes information of at least the legal proceeding and the two or more parties;
identify one or more discovery questions for the legal party to answer, wherein the discovery questions are received from the another legal party;
display a first inquiry to the legal party via the user interface, wherein the first inquiry is associated with the selected one or more discovery questions;
receive a first response from the legal party via the user interface, wherein the first response is associated with the information requested by the first inquiry; and
generate a discovery question response to at least one identified discovery question, wherein the discovery question response includes at least the first response.

12. The computing device of claim 11, wherein the processor is further configured to dynamically select a second inquiry to be displayed to the legal party based on the first response received.

13. The computing device of claim 11, wherein the processor is further configured to designate at least one discovery question to serve to an opposing legal party from the one or more discovery questions determined to be relevant to the legal proceeding.

14. The computing device of claim 11, wherein the processor is further configured to generate a document containing the plurality of discovery questions.

15. The computing device of claim 11, wherein the processor is further configured to:
retrieve one or more proposed objections for each identified discovery question;
display the one or more retrieved proposed objections in the user interface, wherein at least one proposed objection is selectable via the user interface; and
generate a document containing the plurality of discovery responses and corresponding requested discovery question and the corresponding selected one or more objections.
